(19) United States
(12) Patent Application Publication
(10) Pub. No.: US 2022/0198301 A1
(43) Pub. Date: Jun. 23, 2022

(54) METHOD AND APPARATUS FOR UPDATE PROCESSING OF QUESTION ANSWERING SYSTEM

(71) Applicant: BEIJING BAIDU NETCOM SCIENCE AND TECHNOLOGY CO., LTD., Beijing (CN)

(72) Inventors: Guiyuan GU, Beijing (CN); Zhenyu JIAO, Beijing (CN); Shuqi SUN, Beijing (CN); Yue CHANG, Beijing (CN); Tingting LI, Beijing (CN)

(73) Assignee: BEIJING BAIDU NETCOM SCIENCE AND TECHNOLOGY CO., LTD., Beijing (CN)

(21) Appl. No.: 17/346,794

(22) Filed: Jun. 14, 2021

(30) Foreign Application Priority Data
Dec. 18, 2020 (CN) 202011503415.2

(51) Int. Cl. G06N 5/04; G06N 20/00

(52) U.S. Cl. CPC G06N 5/04; G06N 20/00

(57) ABSTRACT

The present disclosure provides a method and apparatus for update processing of a question answering system, relates to the technical field of artificial intelligence and specifically to big data and natural language processing technologies. A specific implementation solution is: acquiring an updated question-answer set; comparing blocks of the updated question-answer set with blocks of an original question-answer set in terms of question-answer pairs to determine an unchanged block and a changed block; acquiring feature data of questions included in the changed block, and creating an index file corresponding to the block, and adding the feature data to an updated training output set; and retaining the index file and feature data corresponding to the unchanged block, and adding the feature data to the updated training output set. The present disclosure can reduce the time consumed in the updating process and occupation of resources.

### CROSS-REFERENCE TO RELATED APPLICATIONS

The present application claims the priority of Chinese Patent Application No. 202011503415.2, filed on Dec. 18, 2020, with the title of “Method and apparatus for update processing of question answering system.” The disclosure of the above application is incorporated herein by reference in its entirety.

### TECHNICAL FIELD

The present disclosure relates to technical field of computer application, and particularly to big data and natural language processing technologies in the technical field of artificial intelligence.

### BACKGROUND

To meet users' needs to quickly and accurately acquire information, research on Question Answering Systems (QAS) has gradually arisen. QAS is an advanced form of information retrieval system, and can use accurate and indirect natural language to answer questions asked by users in natural language, wherein answering Frequently Asked Questions (FAQ) is a main means of providing online help on the current network, and services are provided to users through some pre-organized commonly-used question-answer pairs.

In the FAQ question answering system, after the user enters a question, an answer which is in a pre-configured question-answer set and corresponds to a question matched with the user-entered question is determined in a similarity matching manner. The similarity matching process requires the acquisition of features of the user-entered problem and features of problems in the question-answer set. To quicken the above response process, the FAQ question answering system will pre-train with respect to the problems in the question-answer set to obtain the features of the problems, and use the features of the problems obtained from the training to create an index file in the form of a json file.

However, during practical application, the question-answer set in the FAQ question answering system is updated constantly according to needs in actual services. When the scale of the question-answer set is large, it is necessary to, upon updating each time, upload the whole index file and acquire the features of the problems from upstream and update the whole index file. The whole process takes a long time and occupies a lot of resources.

### SUMMARY

In view of the above, the present disclosure provides a method and apparatus for update processing of a question answering system, to facilitate reducing the time consumed in the updating process and occupation of resources.

In a first aspect, the present disclosure provides a method for update processing of a question answering system, including: acquiring an updated question-answer set; comparing blocks of the updated question-answer set with blocks of an original question-answer set in terms of question-answer pairs to determine an unchanged block and a changed block; acquiring feature data of questions included in the changed block, creating an index file corresponding to the block, and adding the feature data to an updated training output set; retaining the index file and feature data corresponding to the unchanged block, and adding the feature data to the updated training output set.

In a second aspect, the present disclosure provides an electronic device, including: at least one processor; and a memory communicatively connected with the at least one processor; wherein the memory stores instructions executable by the at least one processor, and the instructions are executed by the at least one processor to enable the at least one processor to perform a method for update processing of a question answering system, wherein the method includes: acquiring an updated question-answer set; comparing blocks of the updated question-answer set with blocks of an original question-answer set in terms of question-answer pairs to determine an unchanged block and a changed block; acquiring feature data of questions included in the changed block, creating an index file corresponding to the block, and adding the feature data to an updated training output set; retaining the index file and feature data corresponding to the unchanged block, and add the feature data to the updated training output set.

In a third aspect, the present disclosure provides a non-transitory computer readable storage medium with computer instructions stored thereon, wherein the computer instructions are used for causing a computer to perform a method for update processing of a question answering system, wherein the method includes: acquiring an updated question-answer set; comparing blocks of the updated question-answer set with blocks of an original question-answer set in terms of question-answer pairs to determine an unchanged block and a changed block; acquiring feature data of questions included in the changed block, creating an index file corresponding to the block, and adding the feature data to an updated training output set; retaining the index file and feature data corresponding to the unchanged block, and adding the feature data to the updated training output set. It can be seen from the above technical solutions that in the block division manner, whenever the question-answer set is updated, it is only necessary to acquire the feature data of the question-answer pair corresponding to the changed block and update the index file corresponding to the block. Regarding the unchanged block, the index file and feature data are directly re-used, thereby reducing the consumption of time and occupation of resources.

Other effects of the above aspect or possible implementations will be described below in conjunction with specific embodiments.

### BRIEF DESCRIPTION OF THE DRAWINGS

The figures are intended to facilitate understanding the solutions, not to limit the present disclosure. In the figures,

FIG. 1 illustrates an exemplary system architecture to which embodiments of the present disclosure may be applied;

FIG. 2 illustrates a flow chart of a main method according to embodiments of the present disclosure;

FIG. 3 illustrates a flow chart of another method according to embodiments of the present disclosure;

FIG. 4 illustrates a flow chart of a preferred method of step 202 according to embodiments of the present disclosure;

FIG. 5 illustrates a structural schematic diagram of an apparatus according to embodiments of the present disclosure;

FIG. 6 illustrates a block diagram of an electronic device for implementing the method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

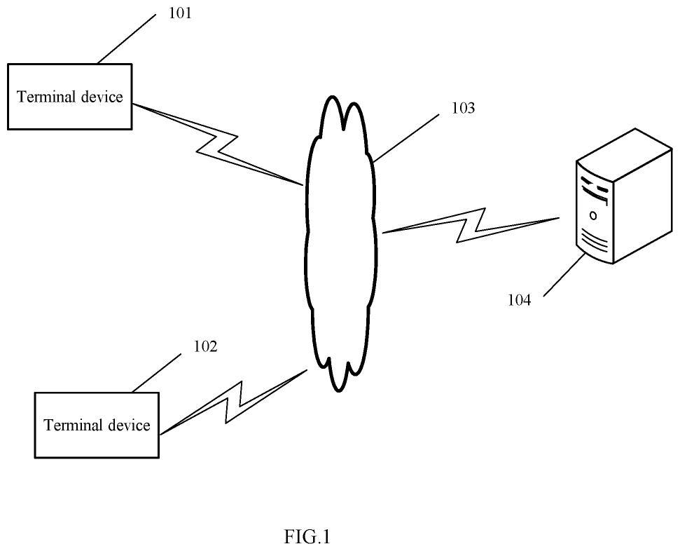

FIG. 1 illustrates an exemplary system architecture to which a method for update processing of a question answering system or an apparatus for update processing of a question answering system according to embodiments of the present disclosure may be applied.

As shown in FIG. 1, the system architecture may comprise terminal devices 101 and 102, a network 103 and a server 104. The network 103 is used to provide a medium for a communication link between the terminal devices 101, 102 and the server 104. The network 103 may comprise various connection types such as wired communication link, a wireless communication link or an optical fiber cable.

The user may use the terminal devices 101 and 102 to interact with the server 104 via the network 103. The terminal devices 101 and 102 may have various applications installed thereon, such as webpage browser applications, communication-type applications, speech interaction applications, multimedia play applications, etc.

The terminal devices 101 and 102 may be various electronic devices which may be devices with or without a screen, may include but not limited to smart phones, tablet computers, smart sound box, intelligent TV sets, PC (Personal Computer) etc. The apparatus for update processing of the question answering system according to the present disclosure may be disposed in or run in the server 104. The apparatus may be implemented as a plurality of software or software modules (e.g., for providing distributed service) or as a single software or software module, which will not be limited in detail herein.

For example, the apparatus for update processing of the question answering system is disposed in and runs in the server 104, and performs update processing for the question answering system in a manner provided by embodiments of the present disclosure. When the user sends a question through the terminal device 101, the server 104 may determine an answer corresponding to the question in the question answering system, and return the answer to the terminal device 101.

The server 104 may be a single server or a server group consisting of a plurality of servers. The question answering system may be disposed in the server 104, or in other servers other than the server 104. It should be appreciated that the number of the terminal devices, networks and servers in FIG. 1 is only for illustration purpose. Any number of terminal devices, networks and servers are feasible according to the needs in implementations.

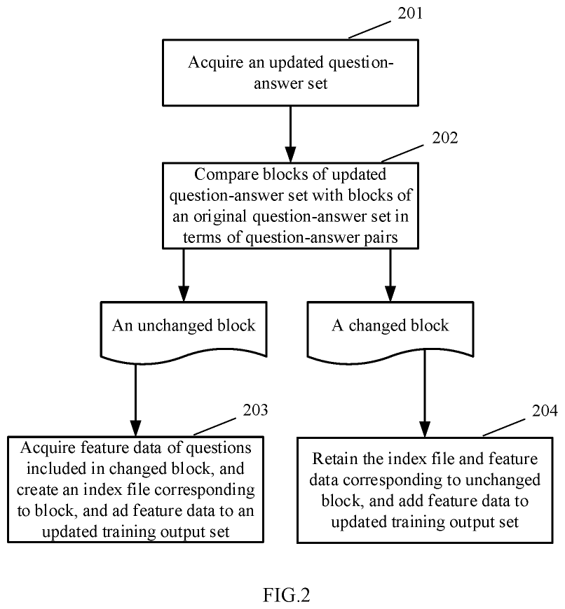

FIG. 2 illustrates a flow chart of a main method according to embodiments of the present disclosure. As shown in FIG. 2, the method may comprise the following steps:

At 201, an updated question-answer set is acquired.

Since the question-answer set needs to be updated according to practical service demands, the updated question-answer set is acquired in this step. The updated question-answer set may be acquired periodically, or acquired based on a trigger of a specific event, e.g., a trigger of an administrator's request event.

At 202, blocks of the updated question-answer set are compared with blocks of an original question-answer set in terms of question-answer pairs to determine an unchanged block and a changed block.

In the embodiment of the present disclosure, the whole question-answer set is divided into blocks, i.e., divided into a plurality of data blocks containing question-answer pairs. After the updated question-answer set is acquired, the blocks of the updated question-answer set are compared with blocks of the original question-answer set in terms of question-answer pairs to determine the unchanged block and changed block. The unchanged block means that all question-answer pairs in the block are not updated. The changed block means that question-answer pairs in the block are updated, or is a newly-created block. A manner of determining various types of blocks will be described in detail in subsequent embodiments.

At 203, feature data of questions included in the changed block are acquired, and an index file corresponding to the block is created, and the feature data is added to an updated training output set.

At 204, the index file and feature data corresponding to the unchanged block are retained, and the feature data is added to the updated training output set.

The question answering system needs to calculate similarity between problems based on the feature data of the problems during a problem matching process, thereby performing preliminary screening and determination of the problems. Therefore, to quicken the problem matching process, an upstream function module usually pre-trains to obtain the feature data of the problems, and the question answering system puts the feature data of the problems into the training output set for direct use in the subsequent problem matching process.

The feature data of the problems is usually obtained according to information such as words obtained by performing word segmentation processing on the problems, and weights of the words. A specific training manner may employ a currently already mature technique, and will not be detailed any more here.

Regarding the unchanged block, the corresponding index file and feature data are retained without need to acquire the feature data corresponding to the question-answer pairs any longer from the upstream, the feature data may be directly re-used, i.e., the feature data is directly added to the updated training output set. However, regarding the changed block, it is necessary to acquire, from the upstream, the feature data of the question-answer pair included by the changed block, and re-create the index file corresponding to the block and add the feature data into the updated training output set.

It can be seen that in the above embodiment, in the block division manner, whenever the question-answer set is updated, it is only necessary to acquire the feature data of the question-answer pair corresponding to the changed block and update the index file corresponding to the block. Regarding the unchanged block, the index file and feature data are directly re-used, thereby reducing the consumption of time and occupation of resources.

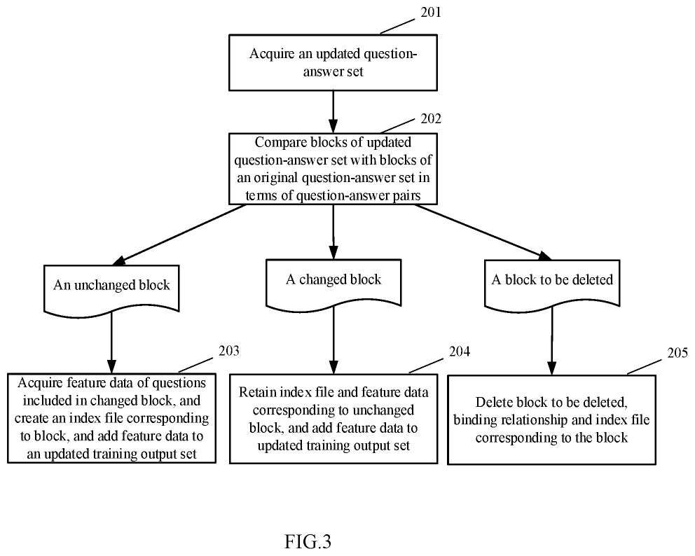

Furthermore, a block to be deleted might also be determined upon comparison as stated in step 202. That is, if all question-answer pairs in a certain block do not exist in the updated question-answer set, the block is the block to be deleted. At this time, as shown in FIG. 3, it is necessary to further perform 105 to delete the block, a binding relationship and the index file corresponding to the block.

An implementation mode of the step 202 “comparing blocks of the updated question-answer set with blocks of an original question-answer set in terms of question-answer pairs to determine an unchanged block and a changed block” will be described in detail below in conjunction with an embodiment.

Regarding the question-answer set determined for the first time, the portion of question-answer set is divided into blocks, and a preset number of question-answer pairs are allocated to one block. The question-answer set may be divided into blocks randomly, in a certain order, or according to common attributes, etc. This is not limited in the present disclosure.

Each block corresponds to one block ID. An index file is created for the block after the feature data corresponding to the problems in the block are acquired from upstream. The index file includes IDs of respective question-answer pairs. The ID can solely identify one question-answer pair, and is usually generated based on the content of the question-answer pair. For example, a message digest algorithm may be employed for processing to obtain a message digest value, e.g., MD5 value. The message digest value such as MD5 value may be employed to solely identify one question-answer pair based on the content, the MD5 value will not be altered as long as the content of the question-answer pair is not altered. If the content of the question-answer pair is altered, the MD5 value is also altered. As such, the changed question-answer pair and the unchanged question-answer pair can be determined quickly.

Furthermore, a binding relationship between the IDs of the blocks and the MD5 values of the question-answer pairs included by the block is created. Through the binding relationship, the block where the question-answer pair lies can be determined quickly from the MD5 value of the question-answer pair. The binding relationship may be stored as a file.

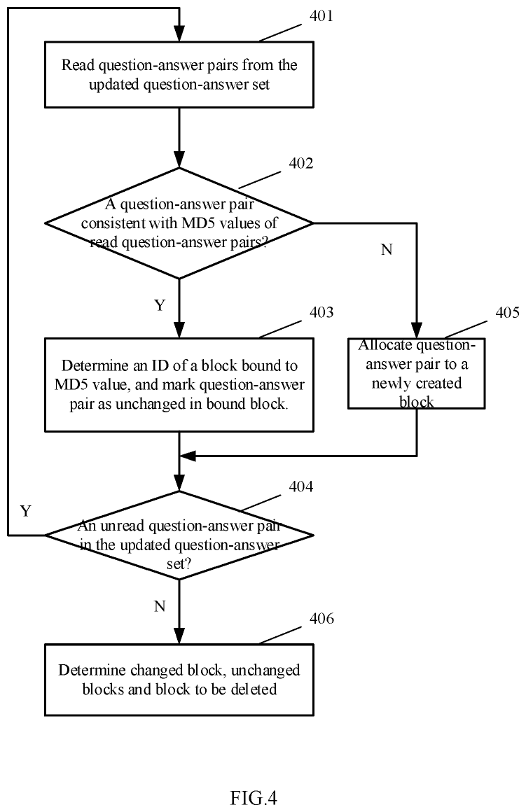

As a preferred implementation mode, after the updated question-answer set is acquired, the implementation process of the above step 202 may comprise the following steps as shown in FIG. 4:

At 401, question-answer pairs are read from the updated question-answer set.

In this step, unread question-answer pairs are read one by one from the updated question-answer set and subsequent steps are executed to achieve comparison between blocks of the updated question-answer set and the blocks of the original question-answer set.

At 402, according to the MD5 values of the read question-answer pairs, query is performed in the original question-answer set to find whether there is a question-answer pair consistent with the MD5 values of the read question-answer pairs. If YES, 403 is performed; otherwise, 405 is performed.

Since the original question-answer set generates MD5 values for all question-answer pairs and the binding relationship between MD5 values and blocks, whether the question-answer pair read from the updated question-answer set already exists in the original question-answer set and in which block the question-answer pair specifically exists can be determined quickly through the comparison of MD5 values.

At 403, an ID of a block bound to the MD5 value is determined, and the question-answer pair is marked as unchanged in the bound block.

At 404, it judges whether there is an unread question-answer pair in the updated question-answer set, and if YES, the processing turns to 401 to continue to read the question-answer pair from the updated question-answer set, or otherwise, it performs step 406.

At 405, it allocates the question-answer pair to a newly created block, and performs step 404.

When a block is newly created, it is still guaranteed the block stores a preset number of question-answer pairs. After a block contains a preset number of question-answer pairs, another block is newly created to continue to store the question-answer pairs.

At 406, it determines the changed block, the unchanged blocks and the block to be deleted.

If there are unmarked question-answer pairs in a block, which indicates that these question-answer pairs do not exist in the updated question-answer set, these question-answer pairs are deleted from the block.

If all question-answer pairs in a block have not changed, the block is determined as the unchanged block.

If partial question-answer pairs in a block are deleted, the block is determined as the changed block. In addition, the newly created block is also determined as the changed block.

If all question-answer pairs in a block are deleted, the block is determined as the block to be deleted.

After the process shown in FIG. 4, three types of blocks can be determined: the changed block, the unchanged block and the block to be deleted.

As for the unchanged block, the index file and binding relationship of the block may be directly retained, and the feature data of the problems in the block may be reused, and these feature data may be directly added to the updated training output set.

As for the changed block, the binding relationship between the MD5 values of the question-answer pairs and the ID of the block is re-generated for the block, the feature data of the question-answer pairs contained in the block is acquired from the upstream, the acquired feature data is added to the updated training output set, and the index file is recreated for the block.

As for the block to be deleted, the block, the ID of the block, the binding relationship of the ID of the block and the index file of the block are deleted.

The training output set obtained after the above processing is the training output set corresponding to the updated question-answer set, and mainly contains the feature data corresponding to the questions in the updated question-answer set. In the subsequent practical application, the question matching process of the question answering system is implemented based on the feature data of questions in the training output set.

The method according to the present disclosure is described in detail above. An apparatus according to the present disclosure will be described below in detail in conjunction with embodiments.

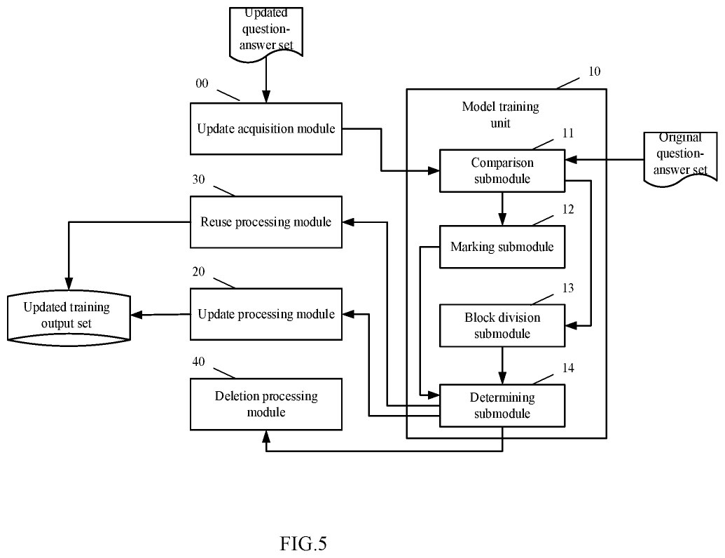

FIG. 5 illustrates a structural schematic diagram of an apparatus according to an embodiment of the present disclosure. The apparatus may be an application located at a server end, or may also be a functional unit such as a plug-in or Software Development Kit (SDK) located in the application of the server end, or may be located at a computer terminal having a strong computing capability. This is not particularly limited in embodiments of the present disclosure. As shown in FIG. 5, the apparatus an update acquisition module 00, a block processing module 10, an update processing module 20 and a reuse processing module 30, and may further comprise a deletion processing module 40. Main functions of the units are as follows:

The update acquisition module 00 is configured to acquire an updated question-answer set.

The updated question-answer set may be acquired periodically, or acquired based on a trigger of a specific event, e.g., a trigger of an administrator's request event.

The block processing module 10 is configured to compare blocks of the updated question-answer set with blocks of an original question-answer set in terms of question-answer pairs to determine an unchanged block and a changed block.

The update processing module 20 is configured to acquire feature data of questions included in the changed block, and create an index file corresponding to the block, and add the feature data to an updated training output set.

The reuse processing module 30 is configured to retain the index file and feature data corresponding to the unchanged block, and add the feature data to the updated training output set.

A binding relationship exists between the IDs of the blocks and IDs of the question-answer pairs included in the block. As a preferred implementation mode, the IDs of the question-answer pairs may include: a message digest value obtained by performing message digest algorithm processing for the question-answer pairs, such as a MD5 value.

As a preferred implementation mode, the block processing module 10 may specifically comprise: a comparison submodule 11, a marking submodule 12, a block division submodule 13 and a determining submodule 14.

The comparison submodule 11 is configured to, according to the ID of each question-answer pair included in the updated question-answer set, query in the original question-answer set to find whether there is a question-answer pair consistent with the ID, and determine the ID of the block bound by the question-answer pair consistent with the ID.

The marking submodule 12 is configured to, if the comparison submodule 11 finds a question-answer pair consistent with the ID by querying the original question-answer set, mark the question-answer pair as unchanged in the bound block.

The block division submodule 13 is configured to, if the comparison submodule 11 fails to find a question-answer pair consistent with the ID by querying the original question-answer set, allocate the question-answer pair to a newly-created block.

The determining submodule 14 is configured to, after query performed by the comparison submodule 11 with respect to all question-answer pairs included by the updated question-answer set is completed and if all question-answer pairs in the block do not change, determine the block as an unchanged block; delete unmarked question-answer pairs from the block, and determine a block from which partial question-answer pairs are deleted and newly-created block as changed blocks.

The deletion processing module 40 is configured to, if all question-answer blocks in the block are deleted, delete the block, the binding relationship and the index file corresponding to the block.

According to embodiments of the present disclosure, the present disclosure further provides an electronic device, a readable storage medium and a computer program product.

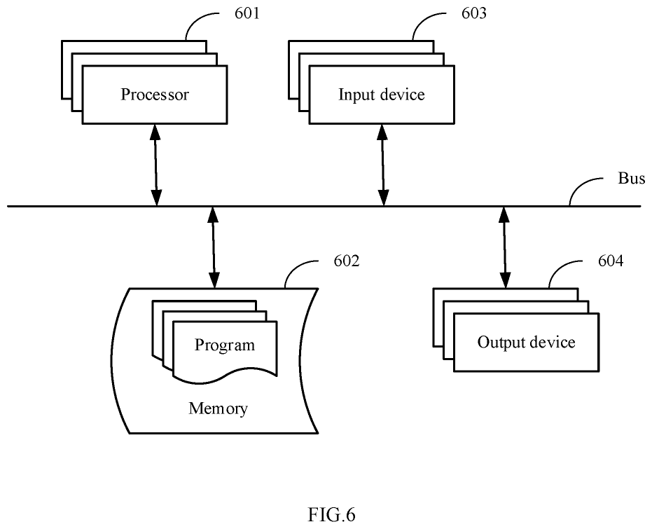

As shown in FIG. 6, it shows a block diagram of an electronic device for implementing the method for update processing of a question answering system according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 6, the electronic device comprises: one or more processors 601, a memory 602, and interfaces configured to connect components and including a high-speed interface and a low speed interface. Each of the components are interconnected using various buses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 601 is taken as an example in FIG. 6.

The memory 602 is a non-transitory computer-readable storage medium provided by the present disclosure. The memory stores instructions executable by at least one processor, so that the at least one processor executes the method for update processing of a question answering system according to the present disclosure. The non-transitory computer-readable storage medium of the present disclosure stores computer instructions, which are used to cause a computer to execute the method for update processing of a question answering system according to the present disclosure.

The memory 602 is a non-transitory computer-readable storage medium and can be used to store non-transitory software programs, non-transitory computer executable programs and modules, such as program instructions/modules corresponding to the method for update processing of a question answering system in embodiments of the present disclosure. The processor 601 executes various functional applications and data processing of the server, i.e., implements the method for update processing of a question answering system in the above method embodiments, by running the non-transitory software programs, instructions and modules stored in the memory 602.

The memory 602 may include a storage program region and a storage data region, wherein the storage program region may store an operating system and an application program needed by at least one function; the storage data region may store data created according to the use of the electronic device. In addition, the memory 602 may include a high-speed random access memory, and may also include a non-transitory memory, such as at least one magnetic disk storage device, a flash memory device, or other non-transitory solid-state storage device. In some embodiments, the memory 602 may optionally include a memory remotely arranged relative to the processor 601, and these remote memories may be connected to the electronic device through a network. Examples of the above network include, but are not limited to, the Internet, an intranet, a local area network, a mobile communication network, and combinations thereof.

The electronic device for implementing the route planning method may further include an input device 603 and an output device 604. The processor 601, the memory 602, the input device 603 and the output device 604 may be connected through a bus or in other manners. In FIG. 6, the connection through the bus is taken as an example.

The input device 603 may receive inputted numeric or character information and generate key signal inputs related to user settings and function control of the electronic device, and may be an input device such as a touch screen, keypad, mouse, trackpad, touchpad, pointing stick, one or more mouse buttons, trackball and joystick. The output device 604 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for update processing of a question answering system, comprising:
acquiring an updated question-answer set;
comparing blocks of the updated question-answer set with blocks of an original question-answer set in terms of question-answer pairs to determine an unchanged block and a changed block;
acquiring feature data of questions included in the changed block, creating an index file corresponding to the block, and adding the feature data to an updated training output set;
retaining the index file and feature data corresponding to the unchanged block, and adding the feature data to the updated training output set.

2. The method according to claim 1, wherein a binding relationship exists between IDs of the blocks and IDs of the question-answer pairs included in the block;
the comparing blocks of the updated question-answer set with blocks of an original question-answer set in terms of question-answer pairs comprises:
according to the ID of each question-answer pair included in the updated question-answer set, querying in the original question-answer set to find whether there is a question-answer pair consistent with the ID, and determining the ID of the block bound by the question-answer pair consistent with the ID.

3. The method according to claim 2, wherein the determining an unchanged block and a changed block comprises:
if a question-answer pair consistent with the ID is found by querying the original question-answer set, marking the question-answer pair as unchanged in the bound block; if a question-answer pair consistent with the ID is not found by querying the original question-answer set, allocating the question-answer pair to a newly-created block;
after completion of the comparison, if all question-answer pairs in the block do not change, determining the block as an unchanged block; deleting unmarked question-answer pairs from the block, and determining a block from which partial question-answer pairs are deleted and newly-created block as changed blocks.

4. The method according to claim 3, further comprising:
if all question-answer blocks in the block are deleted, deleting the block, the binding relationship and the index file corresponding to the block.

5. The method according to claim 3, wherein the IDs of the question-answer pairs comprise: a message digest value obtained by performing message digest algorithm processing for the question-answer pairs.

6. The method according to claim 2, wherein the IDs of the question-answer pairs comprise: a message digest value obtained by performing message digest algorithm processing for the question-answer pairs.

7. An electronic device, comprising:
at least one processor; and
a memory communicatively connected with the at least one processor;
wherein the memory stores instructions executable by the at least one processor, and the instructions are executed by the at least one processor to enable the at least one processor to perform a method for update processing of a question answering system, wherein the method comprises:
acquiring an updated question-answer set;
comparing blocks of the updated question-answer set with blocks of an original question-answer set in terms of question-answer pairs to determine an unchanged block and a changed block;
acquiring feature data of questions included in the changed block, creating an index file corresponding to the block, and adding the feature data to an updated training output set;
retaining the index file and feature data corresponding to the unchanged block, and adding the feature data to the updated training output set.

8. The electronic device according to claim 7, wherein a binding relationship exists between IDs of the blocks and IDs of the question-answer pairs included in the block;
the comparing blocks of the updated question-answer set with blocks of an original question-answer set in terms of question-answer pairs comprises:
according to the ID of each question-answer pair included in the updated question-answer set, querying in the original question-answer set to find whether there is a question-answer pair consistent with the ID, and determine the ID of the block bound by the question-answer pair consistent with the ID.

9. The electronic device according to claim 8, wherein the determining an unchanged block and a changed block comprises:
if a question-answer pair consistent with the ID is found by querying the original question-answer set, marking the question-answer pair as unchanged in the bound block; if a question-answer pair consistent with the ID is not found by querying the original question-answer set, allocating the question-answer pair to a newly-created block;
after completion of the comparison, if all question-answer pairs in the block do not change, determining the block as an unchanged block; deleting unmarked question-answer pairs from the block, and determining a block from which partial question-answer pairs are deleted and newly-created block as changed blocks.

10. The electronic device according to claim 9, further comprising:
if all question-answer blocks in the block are deleted, deleting the block, the binding relationship and the index file corresponding to the block.

11. The electronic device according to claim 9, wherein the IDs of the question-answer pairs comprise: a message digest value obtained by performing message digest algorithm processing for the question-answer pairs.

12. The electronic device according to claim 8, wherein the IDs of the question-answer pairs comprise: a message digest value obtained by performing message digest algorithm processing for the question-answer pairs.

13. A non-transitory computer readable storage medium with computer instructions stored thereon, wherein the computer instructions are used for causing a computer to perform a method for update processing of a question answering system, wherein the method comprises:
acquiring an updated question-answer set;
comparing blocks of the updated question-answer set with blocks of an original question-answer set in terms of question-answer pairs to determine an unchanged block and a changed block;
acquiring feature data of questions included in the changed block, creating an index file corresponding to the block, and adding the feature data to an updated training output set;
retaining the index file and feature data corresponding to the unchanged block, and adding the feature data to the updated training output set.

14. The non-transitory computer readable storage medium according to claim 13, wherein a binding relationship exists between IDs of the blocks and IDs of the question-answer pairs included in the block;
the comparing blocks of the updated question-answer set with blocks of an original question-answer set in terms of question-answer pairs comprises:
according to the ID of each question-answer pair included in the updated question-answer set, querying in the original question-answer set to find whether there is a question-answer pair consistent with the ID, and determining the ID of the block bound by the question-answer pair consistent with the ID.

15. The non-transitory computer readable storage medium according to claim 14, wherein the determining an unchanged block and a changed block comprises:
if a question-answer pair consistent with the ID is found by querying the original question-answer set, marking the question-answer pair as unchanged in the bound block; if a question-answer pair consistent with the ID is not found by querying the original question-answer set, allocating the question-answer pair to a newly-created block;
after completion of the comparison, if all question-answer pairs in the block do not change, determining the block as an unchanged block; deleting unmarked question-answer pairs from the block, and determining a block from which partial question-answer pairs are deleted and newly-created block as changed blocks.

16. The non-transitory computer readable storage medium according to claim 15, further comprising:
if all question-answer blocks in the block are deleted, deleting the block, the binding relationship and the index file corresponding to the block.

17. The non-transitory computer readable storage medium according to claim 15, wherein the IDs of the question-answer pairs comprise: a message digest value obtained by performing message digest algorithm processing for the question-answer pairs.

18. The non-transitory computer readable storage medium according to claim 14, wherein the IDs of the question-answer pairs comprise: a message digest value obtained by performing message digest algorithm processing for the question-answer pairs.
